(19) United States
(12) Patent Application Publication
(10) Pub. No.: US 2025/0026133 A1
(43) Pub. Date: Jan. 23, 2025

(54) IMAGE FORMING APPARATUS

(71) Applicant: KYOCERA Document Solutions Inc., Osaka (JP)

(72) Inventors: Hiroomi Nakatsuji, Osaka (JP); Masato Usui, Osaka (JP); Naoko Kawashima, Osaka (JP); Jun Nakano, Osaka (JP)

(21) Appl. No.: 18/770,969

(22) Filed: Jul. 12, 2024

(30) Foreign Application Priority Data
Jul. 18, 2023 (JP) 2023-116414

(51) Int. Cl. B41J 2/21; G06K 15/02

(52) U.S. Cl. CPC B41J 2/2139; B41J 2/2146; G06K 15/1872; G06K 15/1898; G06K 2215/101

(57) ABSTRACT

An image forming apparatus includes a recording head, a control unit, and a correction processing unit. The recording head is configured to eject ink corresponding to an image to be printed, using nozzles. The control unit is configured to determine nozzles corresponding to the image to be printed, correspondingly to a position of a print sheet, and cause the recording head to eject ink from the nozzles. The correction processing unit is configured to perform for the image after gradation process a correction process corresponding to density anomaly that occurs due to an ejection order of the nozzles. Further, the correction processing unit performs the correction process for a density of a target pixel that the density anomaly occurs in the image after gradation pixel, on the basis of a total of densities of periphery pixels within a predetermined distance from the target pixel.

### CROSS-REFERENCE TO RELATED APPLICATIONS

This application relates to and claims priority rights from Japanese Patent Application No. 2023-116414, filed on Jul. 18, 2023, the entire disclosures of which are hereby incorporated by reference herein.

### BACKGROUND

### 1. Field of the Present Disclosure

The present disclosure relates to an image forming apparatus.

### 2. Description of the Related Art

In an inkjet image forming apparatus, a blank line or a black line due to an ink ejection order and ink ejection malfunction of a nozzle may appear on a printed image and therefore, a correction process is performed to restrain such a blank line or a black line. An image forming apparatus performs a correction process for an image before halftoning with a correction coefficient corresponding to a hitting droplet interference pattern corresponding to an ink ejection order and ink ejection malfunction.

In a line-type inkjet image forming apparatus including a fixed recording head, if an ink ejection position corresponding to a print image is adjusted such that a center of an incoming print sheet in transportation and a center on the print image are agreed with each other correspondingly to a primary-scanning-directional position of the print sheet, (i.e. in an automatic centering function), a nozzle corresponding to each pixel in the print image is selected after start of a printing action (transportation of the print sheet, and the like), and therefore, the correction process of the aforementioned apparatus is hardly performed when using the automatic centering function.

### SUMMARY

An image forming apparatus according to an aspect of the present disclosure includes a recording head, a control unit, and a correction processing unit. The recording head is configured to eject ink corresponding to an image to be printed, using nozzles. The control unit is configured to determine nozzles corresponding to the image to be printed, correspondingly to a position of a print sheet, and cause the recording head to eject ink from the nozzles. The correction processing unit is configured to perform for the image after gradation process a correction process corresponding to density anomaly that occurs due to an ejection order of the nozzles. Further, the correction processing unit performs the correction process for a density of a target pixel that the density anomaly occurs in the image after gradation pixel, on the basis of a total of densities of periphery pixels within a predetermined distance from the target pixel.

These and other objects, features and advantages of the present disclosure will become more apparent upon reading of the following detailed description along with the accompanied drawings.

### BRIEF DESCRIPTION OF THE DRAWINGS

FIG. 1 shows a side view that indicates an internal mechanical configuration of an image forming apparatus in an embodiment according to the present disclosure;

FIG. 2 shows a plane view of an example of recording heads 1a to 1d in the image forming apparatus 10 shown in FIG. 1;

FIG. 3 shows a diagram that indicates an example of a head unit 11 shown in FIG. 2;

FIG. 4 shows a diagram that explains a density anomaly (black line or blank line) due to an ink ejection malfunction;

FIG. 5 shows a block diagram that indicates an electronic configuration of the image forming apparatus 10 in the embodiment according to the present disclosure;

FIG. 6 shows a diagram that explains periphery pixels of a target pixel;

FIG. 7 shows a diagram that indicates an example of periphery density groups;

FIG. 8 shows a diagram that explains ejection order patterns; and

FIG. 9 shows a flowchart that explains a behavior of the image forming apparatus 10 shown in FIGS. 1 to 3.

### DETAILED DESCRIPTION

Hereinafter, an embodiment according to an aspect of the present disclosure will be explained with reference to drawings.

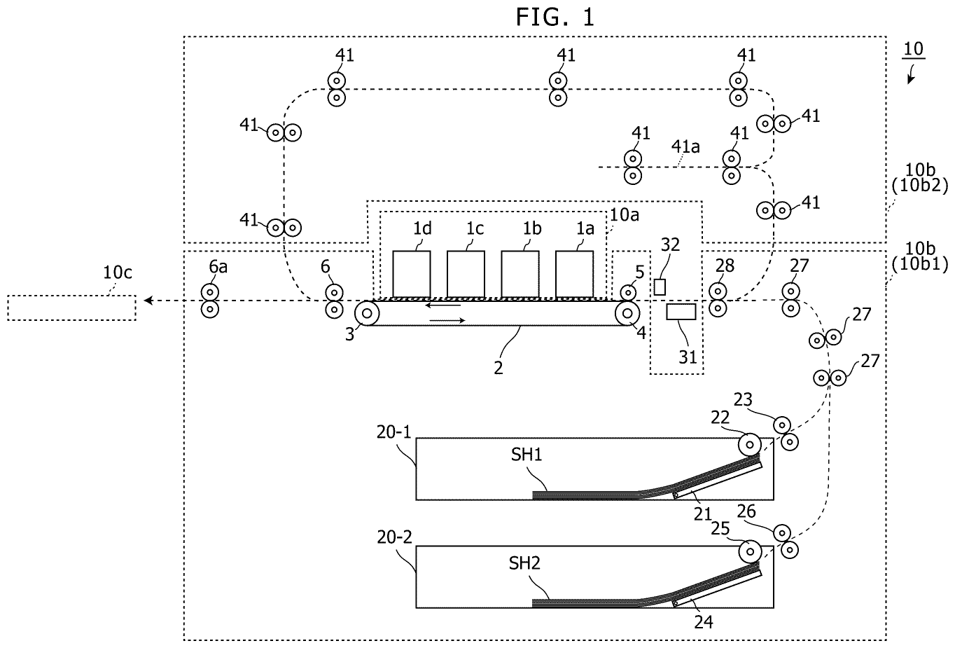

FIG. 1 shows a side view that indicates an internal mechanical configuration of an image forming apparatus in an embodiment according to the present disclosure. The image forming apparatus 10 in this embodiment is an apparatus such as printer, copier, facsimile machine or multi function peripheral.

The image forming apparatus 10 shown in FIG. 1 includes a print engine 10a and a sheet transportation unit 10b. The print engine 10a physically forms an image to be printed on a print sheet (print paper sheet or the like). In this embodiment, the print engine 10a is a line-type inkjet print engine.

In this embodiment, the print engine 10a includes line-type recording heads 1a to 1d corresponding to four ink colors: Cyan, Magenta, Yellow, and Black.

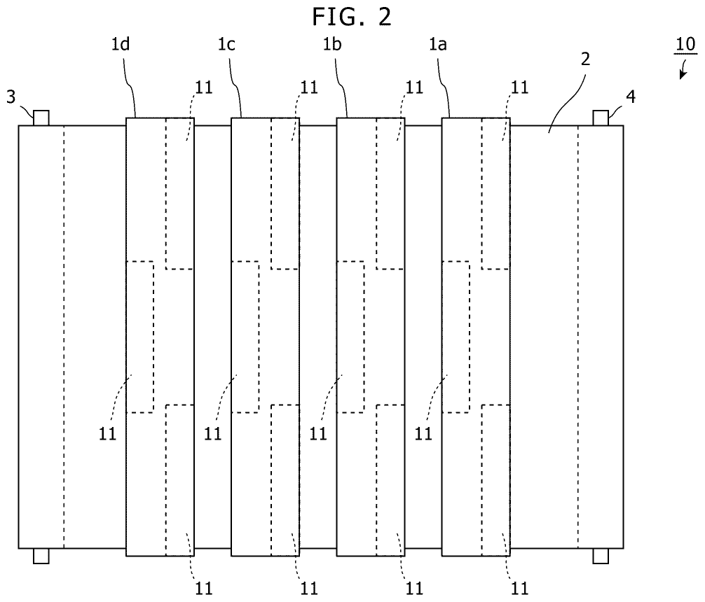

FIG. 2 shows a plane view of an example of recording heads 1a to 1d in the image forming apparatus 10 shown in FIG. 1. As shown in FIG. 2, for example, in this embodiment, each of the inkjet recording units 1a, 1b, 1c and 1d includes plural (here, three) head units 11. The head units 11 are arranged along a primary scanning direction, and are capable of being mounted to and demounted from a main body of the image forming apparatus. Each of the recording heads 1a, 1b, 1c and 1d may include only one head unit 11.

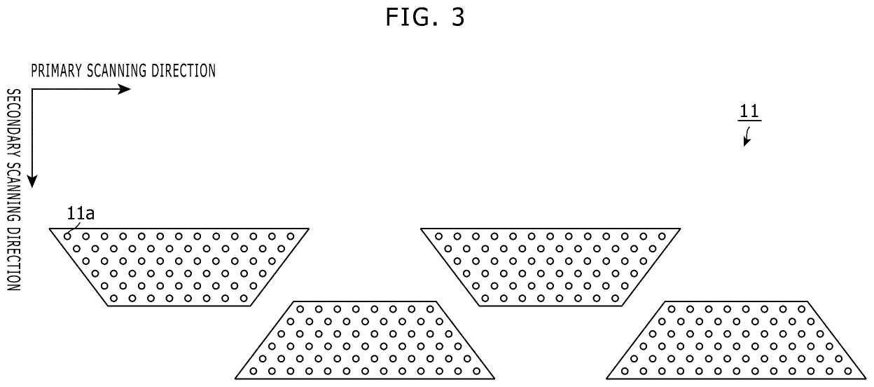

FIG. 3 shows a diagram that indicates an example of a head unit 11 shown in FIG. 2. As shown in FIG. 3, for example, the head unit 11 of the inkjet recording unit 1a, 1b, 1c or 1d includes nozzles 11a 2-dimensionally arranged, and ejects ink corresponding to the image to be printed using the nozzles 11a.

The nozzles 11a of each of the recording heads 1a to 1d are classified into plural nozzle arrays; and when a certain position of a print sheet in a secondary scanning direction (i.e. transportation direction) passes at a position of a nozzle array, an ink droplet is ejected from a nozzle 11a of this nozzle array (i.e. from an early ejection nozzle); and afterward, when this position of the print sheet passes at a position of another nozzle array, an ink droplet is ejected from a nozzle 11a of this nozzle array (i.e. from a late ejection nozzle). Therefore, adjacent to a dot formed with the early-ejected ink droplet (i.e. adjacent to an early ejection dot), formed is a dot formed with the late-ejected ink droplet (late ejection dot).

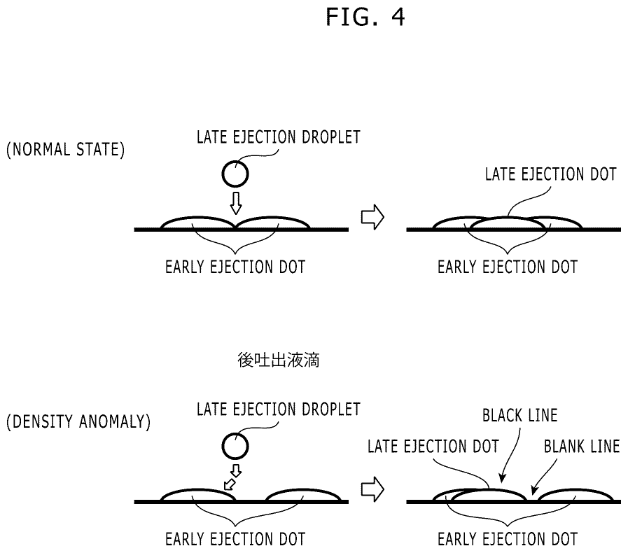

FIG. 4 shows a diagram that explains a density anomaly (black line or blank line) due to an ink ejection malfunction. As shown in FIG. 4, an ink droplet of late ejection may coalesce into a dot formed on a print sheet by early ejection (an early ejection dot), and such coalescence may occur due to unevenness of nozzle intervals or the like. In such a case, an ink droplet of late ejection is attracted by an early ejection dot and thereby a position of a dot formed by late ejection (a late ejection dot) is shifted. Therefore, density anomaly (black line or blank line) may occur. If the target pixel is formed by late ejection, its dot is shifted due to the aforementioned ink droplet coalescence and density defect (blank line) appears at the target pixel; and if the target pixel is formed by early ejection, a dot of an adjacent pixel is shifted to the target pixel due to the aforementioned ink droplet coalescence and density excess (black line) appears at the target pixel.

Returning to FIG. 1, the sheet transportation unit 10b transports the print sheet to the print engine 10a along a predetermined transportation path, and transports the print sheet after printing from the print engine 10a to a predetermined output destination (here, an output tray 10c or the like).

The sheet transportation unit 10b includes a main sheet transportation unit 10b1 and a circulation sheet transportation unit 10b2. In duplex printing, the main sheet transportation unit 10b1 transports to the print engine 10a a print sheet to be used for printing of a first-surface page image, and the circulation sheet transportation unit 10b2 transports the print sheet from a posterior stage of the print engine 10a to a prior stage of the print engine 10a with detaining a predetermined number of print sheets.

In this embodiment, the main sheet transportation unit 10b1 includes (a) a circular-type transportation belt 2 that is arranged so as to be opposite to the print engine 10a and transports a print sheet, (b) a driving roller 3 and a driven roller 4 around which the transportation belt 2 is hitched, (c) a nipping roller 5 that nips the print sheet with the transportation belt 2, and (d) output roller pairs 6 and 6a.

The driving roller 3 and the driven roller 4 rotate the transportation belt 2. The nipping roller 5 nips an incoming print sheet transported from a sheet feeding cassette 20-1 or 20-2 mentioned below, and the nipped print sheet is transported by the transportation belt 2 to printing positions of the inkjet recording units 1a to 1d in turn, and on the print sheet, images of respective colors are printed by the inkjet recording units 1a to 1d. Subsequently, after the color printing, the print sheet is outputted by the output roller pairs 6 and 6a to an output tray 10c or the like.

Further, the main sheet transportation unit 10b1 includes plural sheet feeding cassettes 20-1 and 20-2. The sheet feeding cassettes 20-1 and 20-2 store print sheets SH1 and SH2, and push up the print sheets SH1 and SH2 using lift plates 21 and 24 so as to cause the print sheets SH1 and SH2 to contact with pickup rollers 22 and 25, respectively. The print sheets SH1 and SH2 put on the sheet feeding cassettes 20-1 and 20-2 are picked up to sheet feeding rollers 23 and 26 by the pickup rollers 22 and 25 sheet by sheet from the upper sides, respectively. The sheet feeding rollers 23 and 26 are rollers that transport the print sheets SH1 and SH2 sheet by sheet fed by the pickup rollers 22 and 25 from the sheet feeding cassettes 20-1 and 20-2 onto a transportation path. A transportation roller 27 is a transportation roller on the transportation path common to the print sheets SH1 and SH2 transported from the sheet feeding cassettes 20-1 and 20-2.

When performing duplex printing, the circulation sheet transportation unit 10b2 returns the print sheet from a predetermined position in a downstream side of the print engine 10a to a predetermined position in an upstream side of the print engine 10a (here, to a predetermined position in an upstream side of a line sensor 31 mentioned below). The circulation sheet transportation unit 10b2 includes a transportation roller 41, and a switch back transportation path 41a that reverses a movement direction of the print sheet in order to change a surface that should face the print engine 10a among surfaces of the print sheet from the first surface to the second surface of the print sheet.

Further, the image forming apparatus 10 includes a line sensor 31 and a sheet detecting sensor 32. The line sensor 31 is an optical sensor that is arranged along a direction perpendicular to a transportation direction of the print sheet, and detects positions of both end edges (both side edges) of the print sheet. For example, the line sensor 31 is a CIS (Contact Image Sensor). In this embodiment, the line sensor 31 is arranged at a position between the registration roller 28 and the print engine 10a. The sheet detecting sensor 32 is an optical sensor that detects that a front end of the print sheet SH1 or SH2 passes through a predetermined position on the transportation path. The line sensor 31 detects the positions of the both side end edges at a time point that the front end of the print sheet SH1 or SH2 is detected by the sheet detecting sensor 32.

For example, as shown in FIG. 1, the print engine 10a is arranged in one of an upward part of the transportation path and a downward part of the transportation path (here, in the upward part); the line sensor 31 is arranged in the other of the upward part of the transportation path and the downward part of the transportation path (here, in the downward part); and the circulation transportation unit 10b2 transports the print sheet from the downstream side of the print engine 10a to the upstream side of the line sensor 31 with changing an orientation of the print sheet in a switch back manner.

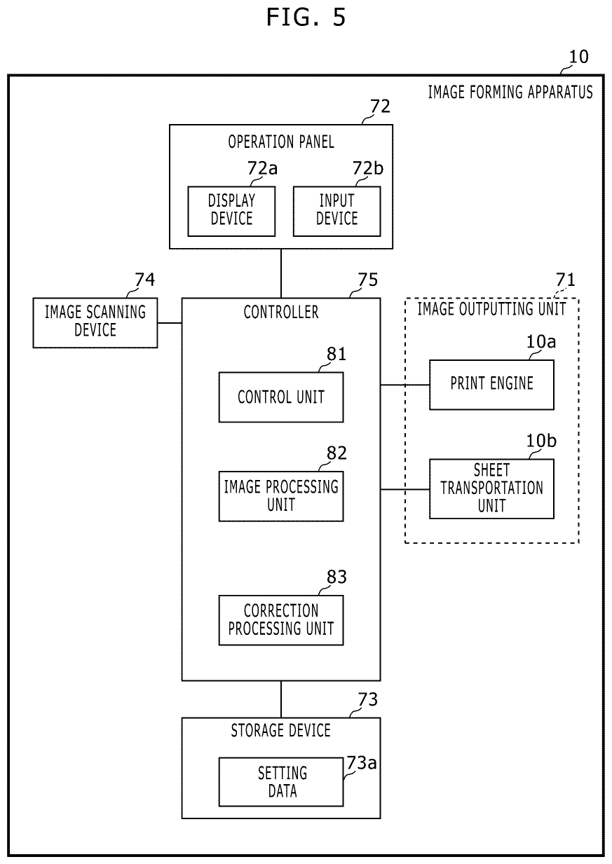

FIG. 5 shows a block diagram that indicates an electronic configuration of the image forming apparatus 10 in the embodiment according to the present disclosure. As shown in FIG. 5, the image forming apparatus 10 includes not only an image outputting unit 71 that includes the mechanical configuration shown in FIGS. 1 to 3 but an operation panel 72, a storage device 73, an image scanning device 74, and a controller 75.

The operation panel 72 is arranged on a housing surface of the image forming apparatus 10, and includes a display device 72a such as a liquid crystal display and an input device 72b such as a hard key and/or a touch panel, and displays sorts of messages for a user using the display device 72a and receives a user operation using the input device 72b.

The storage device 73 is a non-volatile storage device (flash memory, hard disk drive or the like) in which data, a program and the like have been stored that are required for control of the image forming apparatus 10.

The image scanning device 74 includes a platen glass and an auto document feeder, and optically scans a document image from a document put on the platen glass or a document fed by the auto document feeder, and generates image data of the document image.

The controller 75 includes a computer that performs a software process in accordance with a program, an ASIC (Application Specific Integrated Circuit) that performs a predetermined hardware process, and/or the like, and acts as sorts of processing units using the computer, the ASIC and/or the like. This computer includes a CPU (Central Processing Unit), a ROM (Read Only Memory), a RAM (Random Access Memory) and the like, and loads a program stored in the storage device 73, the ROM or the like to the RAM and executes the program using the CPU and thereby acts as processing units (with the ASIC if required). Here, the controller 75 acts as a control unit 81, an image processing unit 82, and a correction processing unit 83.

The control unit 81 controls the image outputting unit 71 (the print engine 10a, the sheet transportation unit 10b and the like), and thereby performs a print job requested by a user. In this embodiment, the control unit 81 causes the image processing unit 82 to perform a predetermined image process, and controls the print engine 10a (the head units 11) and causes the head units 11 to eject ink and thereby forms a print image on a print sheet. The image processing unit 82 performs a predetermined image process such as RIP (Raster Image Processing), color conversion, a gradation process and/or the like for image data of an image to be printed.

Further, in this embodiment, the control unit 81 has an automatic centering function that (a) determines as an actual sheet center position a center position of a print sheet on the basis of the positions of both side end edges of the print sheet detected by the line sensor 31, and (b) adjusts a center position of an image to be printed, on the basis of a difference from the actual sheet center position, and performs the automatic centering function as a hardware process.

Specifically, in the automatic centering function, the control unit 81 changes a depicting position of the image to be printed, in a primary scanning direction by a difference between a reference center position of the print engine 10a and the actual sheet center position. In this embodiment, because the nozzles 11a of the recording heads 1a to 1d do not move, a nozzle corresponding to each pixel in the image to be printed is changed correspondingly to the depicting position of the image to be printed.

As mentioned, the control unit 81 determines nozzles 11a corresponding to the image to be printed (a nozzle 11a corresponding to each pixel), correspondingly to a position of a print sheet, and causes the recording heads 1a to 1d to eject ink from the determined nozzles 11a.

Further, the correction processing unit 83 performs for the image after gradation process a correction process corresponding to density anomaly that occurs due to an ejection order of the nozzles 11a.

In the correction process, within time from determination of a print sheet position to ink ejection, the correction processing unit 83 (a) determines a pixel corresponding to a nozzle 11a that density anomaly occurs due to the aforementioned ink droplet coalescence, i.e. determines a pixel (target pixel) as a target of the correction process in an image to be printed, and (b) performs the correction process for this pixel. The nozzle 11a that density anomaly occurs due to the aforementioned ink droplet coalescence has been determined in advance in accordance with an existent method such as experiment or test using a test pattern or has been determined in advance on the basis of configuration of the recording head 1a, 1b, 1c or 1d, and setting data 73a that indicates this nozzle 11a has been stored in the storage device 73 in advance.

Specifically, the correction processing unit 83 performs the correction process for a density of a target pixel that the density anomaly occurs in the image after gradation pixel, on the basis of a total of densities (here, pixel values that indicates densities) of periphery pixels within a predetermined distance from the target pixel.

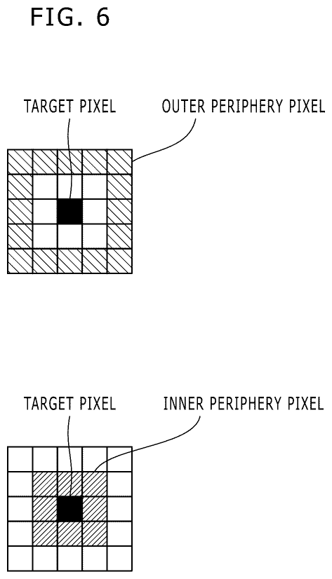

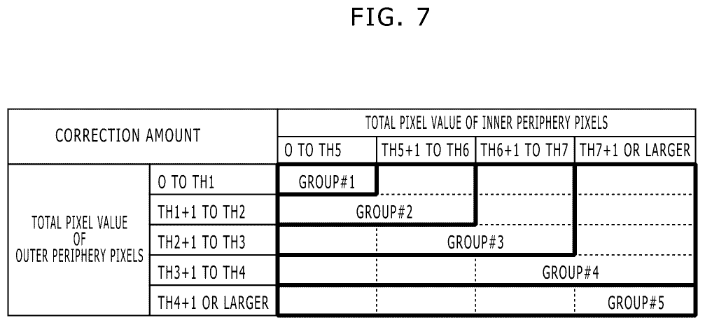

FIG. 6 shows a diagram that explains periphery pixels of a target pixel. FIG. 7 shows a diagram that indicates an example of periphery density groups. In this embodiment, (a) the total on the periphery pixels that the predetermined distance is one pixel (inner periphery pixels shown in FIG. 6) is classified into any of plural density ranges with plural threshold values TH1 to TH4, (b) the total on the periphery pixels that the predetermined distance is two pixels (outer periphery pixels shown in FIG. 6) is classified into any of plural density ranges with plural threshold values TH5 to TH7, (c) as shown in FIG. 7, for example, plural periphery density groups are set on the basis of combinations of the density ranges of the inner periphery pixels and the density ranges of the outer periphery pixels, and (d) correction amounts are set correspondingly to the plural periphery density groups, respectively.

In this embodiment, the correction processing unit 83 (a) determines for the target pixel a periphery density group (any of the Groups #1 to #5 shown in FIG. 7) that a combination of the density total of the inner periphery pixels and the density total of the outer periphery pixels belongs to, (b) determines a correction amount corresponding to the determined periphery density group, and (c) performs the correction process with the determined correction amount. Here a pixel values of the target pixel is increased or decreased by the correction amount.

This correction amount is set such that (a) if the target pixel is an isolated dot, this correction amount is set as zero; and (b) this correction amount increases in accordance with increase of the aforementioned density total of the inner periphery pixels and the aforementioned density total of the outer periphery pixels, and in addition if the aforementioned density total of the inner periphery pixels and the aforementioned density total of the outer periphery pixels exceed a predetermined value, decreases.

Further, when ejection of the target pixel is earlier than ejection of an adjacent pixel in the ejection order, (because density excess appears at the target pixel as mentioned) the correction processing unit 83 performs the correction process so as to decrease a density of the target pixel; and when ejection of the target pixel is later than ejection of an adjacent pixel in the ejection order (because density defect appears at the target pixel as mentioned), the correction processing unit 83 performs the correction process so as to increase a density of the target pixel. Thus, the aforementioned correction amount is set such that the correction process is performed in this manner. Specifically, in case of early ejection, the correction amount is set as a negative value; in case of late ejection, the correction amount is set as a positive value; and a density of the target pixel is corrected to a value obtained by summing the correction amount to a density of the target pixel. Such increase or decrease of a density of the target pixel results in increase or decrease of an amount of an ink droplet to be ejected, and therefore a size of a dot formed by hitting of the ink droplet increases or decreases.

Further, if a density total of the inner periphery pixels is zero and a density total of the outer periphery pixels is zero, the correction processing unit 83 determines that the target pixel is an isolated dot and therefore does not perform the correction process.

Furthermore, when ejection of the target pixel is later than ejection of an adjacent pixel in the ejection order, the correction processing unit 83 does not perform the correction process if the total on the inner periphery pixels is zero and the total on the outer periphery pixels is equal to or less than a predetermined threshold value. Contrarily, when ejection of the target pixel is earlier than ejection of an adjacent pixel in the ejection order, the correction processing unit 83 performs the correction process if the total on the inner periphery pixels is zero and the total on the outer periphery pixels is larger than zero but equal to or less than the predetermined threshold value.

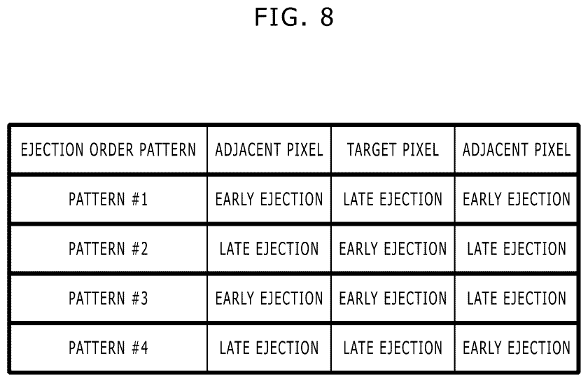

Furthermore, the aforementioned correction amounts are set correspondingly to ejection order patterns. FIG. 8 shows a diagram that explains ejection order patterns. As shown in FIG. 8, Patterns #1 to #4 are set as the ejection order patterns. In Pattern #1, the target pixel is formed by late ejection (i.e. a pixel depicted by a late ejection nozzle), and both of adjacent pixels of the target pixel in a primary scanning direction are formed by early ejection (i.e. a pixel depicted by early ejection nozzles). In Pattern #2, the target pixel is formed by early ejection, and both of the adjacent pixels of the target pixel are formed by late ejection. In Pattern #3, the target pixel is formed by early ejection, and one of the adjacent pixels of the target pixel is formed by late ejection and the other of the adjacent pixels of the target pixel is formed by early ejection. In Pattern #4, the target pixel is formed by late ejection, and one of the adjacent pixels of the target pixel is formed by late ejection and the other of the adjacent pixels of the target pixel is formed by early ejection.

For example, if a pixel value of each pixel in an image to be printed is quantized into four gradation levels of 0, 1, 2 and 3 by the gradation process, the density total of the inner periphery pixels (8 pixels) falls into a range from 0 to 24, and the density total of the outer periphery pixels (16 pixels) falls into a range from 0 to 48. In this case, the threshold values TH1, TH2, TH3, TH4, TH5, TH6 and TH7 are set as 1, 16, 32, 48, 1, 8 and 15, for example. In this case, for Pattern #1, for example, the correction amounts of Groups #1 and #2 in FIG. 7 are set as zero, the correction amount of Group #3 is set as −1, the correction amount of Group #4 is set as −2, and the correction amount of Group #5 is set as −1. Further, in this case, for Pattern #2, for example, the correction amount of Groups #1 in FIG. 7 is set as zero, the correction amounts of Groups #2 and #3 are set as 1, and the correction amounts of Groups #4 and #5 are set as zero. Furthermore, in this case, for Pattern #3, for example, the correction amount of Groups #1 in FIG. 7 is set as zero, the correction amounts of Groups #2, #3 and #4 are set as 1, and the correction amount of Group #5 is set as zero. Furthermore, in this case, for Pattern #4, for example, the correction amounts of Groups #1 and #2 in FIG. 7 are set as zero, and the correction amounts of Group #3, #4 and #5 are set as −1.

These correction amounts for periphery density groups are associated with the periphery density groups, respectively, and have been stored as data in the storage device 73; and the data is referred to derive a correction amount of the target pixel.

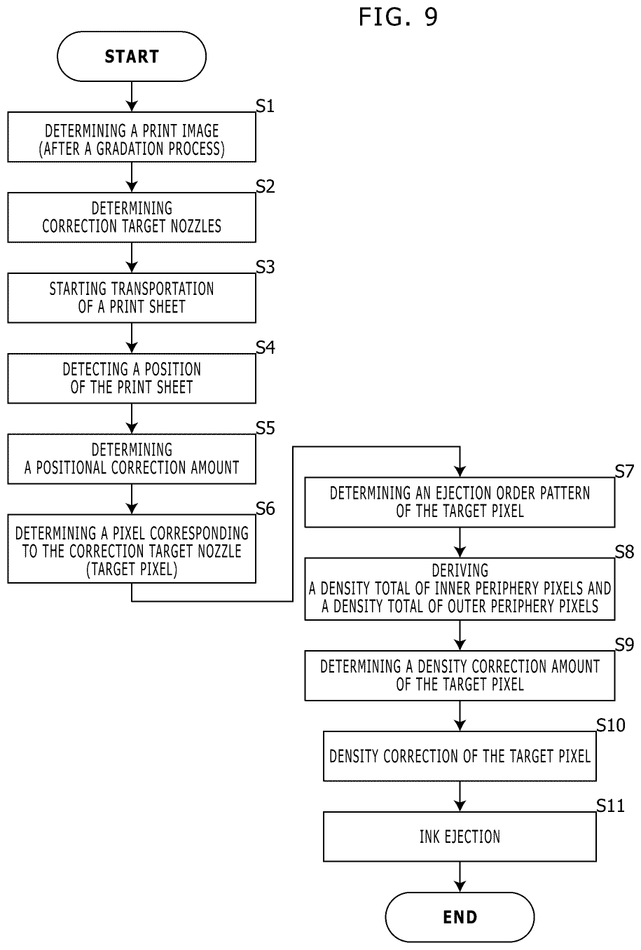

The following part explains a behavior of the image forming apparatus 10. FIG. 9 shows a flowchart that explains a behavior of the image forming apparatus 10 shown in FIGS. 1 to 3.

Upon receiving a print request, the control unit 81 performs an image process such as gradation process for an image specified by the print request using the image processing unit 82 and thereby acquires image data of an image to be printed (an image after the gradation process), and determines the image to be printed (the image after the gradation process) (in Step S1).

Subsequently, the correction processing unit 83 reads the setting data 73a and determines a nozzle 11a as a correction target (in Step S2).

Further, the control unit 81 starts transportation of a print sheet using the image outputting unit 71 (in Step S3), and when a position of the print sheet is detected by the line sensor 31 (in Step S4), the control unit 81 derives a positional correction amount of the image to be printed (in Step S5), and shifts the image to be printed, by the positional correction amount in the primary scanning direction.

The correction processing unit 83 determines a nozzle 11a corresponding to each pixel in the image to be printed that has been shifted by the positional correction amount, and determines a pixel (target pixel) corresponding to the nozzle 11a as a correction target (in Step S6).

Further, the correction processing unit 83 determines an ejection order pattern of the target pixel (in Step S7), and derives a density total of inner periphery pixels of the target pixel and a density total of outer periphery pixels of the target pixel in the image (in Step S8).

Subsequently, the correction processing unit 83 determines a correction amount corresponding to the ejection order pattern and the density totals of the inner periphery pixels and the outer periphery pixels of the target pixel (in Step S9), and increases or decreases a density (pixel value) of the target pixel by the correction amount and thereby performs density correction of the target pixel (in Step S10).

On the basis of the image that the density correction of each target pixel has been performed as mentioned, the control unit 81 causes to eject an ink droplet from the nozzle 11a corresponding to each pixel in the image with an ink droplet amount corresponding to a density (pixel value) of the pixel (in Step S11).

As mentioned, in the aforementioned embodiment, the recording head 1a, 1b, 1c or 1d ejects ink corresponding to an image to be printed, using nozzles 11a. The control unit 81 determines nozzles 11a corresponding to the image to be printed, correspondingly to a position of a print sheet, and causes the recording head 1a, 1b, 1c or 1d to eject ink from the nozzles 11a. The correction processing unit 83 performs for the image after gradation process a correction process corresponding to density anomaly that occurs due to an ejection order of the nozzles 11a. Specifically, the correction processing unit 83 performs the correction process for a density of a target pixel that the density anomaly occurs in the image after gradation pixel, on the basis of a total of densities of periphery pixels within a predetermined distance from the target pixel.

Consequently, even when the automatic centering function is used, the correction process is performed to restrain a blank line or a black line due to an ink ejection order. In addition, a correction amount is determined correspondingly to a periphery density of a target pixel in the correction process, and therefore density correction of the target pixel is properly performed.

It should be understood that various changes and modifications to the embodiments described herein will be apparent to those skilled in the art. Such changes and modifications may be made without departing from the spirit and scope of the present subject matter and without diminishing its intended advantages. It is therefore intended that such changes and modifications be covered by the appended claims.

For example, in the aforementioned embodiment, the image is converted to four gradation levels by the gradation process. Alternatively, the image may be converted to 8 gradation levels, 16 gradation levels or the like by the gradation process.

What is claimed is:

1. An image forming apparatus, comprising:
a recording head configured to eject ink corresponding to an image to be printed, using nozzles;
a control unit configured to determine nozzles corresponding to the image to be printed, correspondingly to a position of a print sheet, and cause the recording head to eject ink from the nozzles; and
a correction processing unit configured to perform for the image after gradation process a correction process corresponding to density anomaly that occurs due to an ejection order of the nozzles;
wherein the correction processing unit performs the correction process for a density of a target pixel that the density anomaly occurs in the image after gradation pixel, on the basis of a total of densities of periphery pixels within a predetermined distance from the target pixel.

2. The image forming apparatus according to claim 1 wherein the correction processing unit does not perform the correction process if the total on the periphery pixels that the predetermined distance is one pixel is zero and the total on the periphery pixels that the predetermined distance is two pixels is zero.

3. The image forming apparatus according to claim 1 wherein when ejection of the target pixel is later than ejection of an adjacent pixel in the ejection order, the correction processing unit does not perform the correction process if the total on the periphery pixels that the predetermined distance is one pixel is zero and the total on the periphery pixels that the predetermined distance is two pixels is equal to or less than a predetermined threshold value; and
when ejection of the target pixel is earlier than ejection of an adjacent pixel in the ejection order, the correction processing unit performs the correction process if the total on the periphery pixels that the predetermined distance is one pixel is zero and the total on the periphery pixels that the predetermined distance is two pixels is larger than zero but equal to or less than the predetermined threshold value.

4. The image forming apparatus according to claim 1 wherein when ejection of the target pixel is earlier than ejection of an adjacent pixel in the ejection order, the correction processing unit performs the correction process so as to decrease a density of the target pixel; and
when ejection of the target pixel is later than ejection of an adjacent pixel in the ejection order, the correction processing unit performs the correction process so as to increase a density of the target pixel.

5. The image forming apparatus according to claim 1 wherein (a) the total on the periphery pixels that the predetermined distance is one pixel is classified into any of plural density ranges with plural threshold values, (b) the total on the periphery pixels that the predetermined distance is two pixels is classified into any of plural density ranges with plural threshold values, (c) plural periphery density groups are set on the basis of combinations of the density ranges of the periphery pixels that the predetermined distance is one pixel and the density ranges of the periphery pixels that the predetermined distance is two pixels, and (d) correction amounts are set correspondingly to the plural periphery density groups, respectively; and
the correction processing unit (a) determines for the target pixel a periphery density group that a combination of the total on the periphery pixels that the predetermined distance is one pixel and the total on the periphery pixels that the predetermined distance is two pixels belongs to, (b) determines a correction amount corresponding to the determined periphery density group, and (c) performs the correction process with the determined correction amount.
